(19) United States
(12) Patent Application Publication
(10) Pub. No.: US 2007/0107547 A1
(43) Pub. Date: May 17, 2007

(54) Machine tool

(76) Inventor: Kazuhiko Oiwa, Yamatokoriyama-shi (JP)

Correspondence Address: SMITH PATENT OFFICE, 1901 PENNSYLVANIA AVENUE N W, SUITE 901, WASHINGTON, DC, 20006, US

(21) Appl. No.: 11/590,917

(22) Filed: Nov. 1, 2006

(30) Foreign Application Priority Data
Nov. 11, 2005 (JP) 2005-326905

(51) Int. Cl. B23Q 16/02

(52) U.S. Cl. 74/815

(57) ABSTRACT

To provide a machine tool capable of processing a work to have a required thickness based on a simple structure without adjusting a distance itself between both cutting tools. A machine tool includes: a spindle rotating around a Z-axis extending in a horizontal direction; a tool post disposed in a movable manner in the Z-axis direction and an X-axis direction orthogonal to the Z-axis direction and in a pivotable manner around a B-axis orthogonal to a plane face containing the X-axis and the Z-axis; a tool having a pair of tips disposed to have a predetermined interval therebetween and fitted to said tool post; and a tool post control unit adjusting a pivot angle of said tool post so that an angle α between a straight line connecting the pair of tips and the Z-axis comes to an angle corresponding to a finished thickness of a work.

### BACKGROUND OF THE INVENTION

1. Field of the Invention

The present invention relates to a machine tool to process both braking faces of a disk plate, which is a main component for example of a disk brake gear for a vehicle, to have a high parallelism.

2. Description of the Related Art

As a machine tool to process braking faces of a disk plate, for example, there is one, in which two cutting tools are placed at positions where brake pads are disposed and the disk plate is rotated by keeping a distance between both the cutting tools to be a required size (for example, refer to Patent document 1).

[Patent document 1] Japanese Patent Application Laid-Open No. 2002-210639

The machine tool described in Patent document 1 has problems that the structure to adjust the distance between the two cutting tools is complicated, and that it is difficult to keep the distance between the two cutting tools to be the required size with high precision.

### SUMMARY OF THE INVENTION

The present invention has been made to bring a solution to the above-described conventional problems, and an object thereof is to provide a machine tool capable of processing a work to have a required thickness without adjusting a distance itself between both cutting tools on the basis of a simple structure.

The present invention in claim 1 is a machine tool including: a spindle rotating around a Z-axis extending in a horizontal direction; a tool post disposed in a movable manner in the Z-axis direction and an X-axis direction orthogonal to the Z-axis direction and in a pivotable manner around a B-axis orthogonal to a plane face containing the X-axis and the Z-axis; a tool including a pair of tips disposed to have a predetermined interval therebetween and fitted to the tool post; and a tool post control unit adjusting a pivot angle of the tool post so that an angle α between a straight line connecting the pair of tips and the Z-axis comes to an angle corresponding to a finished thickness of a work.

The present invention in claim 2 is the machine tool according to claim 1, in which the tool post control unit keeps the angle α constant without regard to a positional change in the X-axis direction of the tool post.

The present invention in claim 3 is the machine tool according to claim 1, in which the tool post control unit changes the angle α in accordance with the positional change in the X-axis direction of the tool post,

The present invention according to claim 4 is a work processing method in a machine tool provided with: a spindle rotating around a Z-axis extending in a horizontal direction; a tool post disposed in a movable manner in the Z-axis direction and an X-axis direction orthogonal to the Z-axis direction and in a pivotable manner around a B-axis orthogonal to a plane face containing the X-axis and the Z-axis; and a tool including a pair of tips disposed to have a predetermined interval therebetween and fitted to the tool post, including: a processing step processing the work in a state where the pivot angle of the tool post is adjusted so that the angle α formed by the straight line connecting the pair of tips and the Z-axis comes to the angle corresponding to the finished thickness of the work; and a stand-by step returning to a stand-by position while it is in the state where the pivot angle of said tool post is adjusted so that the angle α after the processing is smaller than the angle in the course of the processing step.

According to the invention in claim 1, it is structured to adjust the pivot angle of the tool post so that the angle α between the straight line connecting the pair of tips and the Z-axis comes to the angle corresponding to the finished thickness of the work, in which it is not necessary to adjust the distance between the tips in accordance with the finished thickness of the work, allowing the work to be processed to have the finished thickness by a simple control that adjusts only the pivot angle of the tool post.

According to the invention in claim 2, the above-described angle α is made constant without regard to the positional change in the X-axis direction of the tool post, allowing the work to be processed to have a constant thickness in a radius direction.

Further, according to the invention in claim 3, the above-described angle α is made to change in accordance with the positional change in the X-axis direction of the tool post, allowing the work to be processed to have the thickness changing in the radius direction.

According to the invention in claim 4, in the processing step, the processing is made in the state where the pivot angle of the tool post is adjusted so that the angle between the straight line connecting the pair of tips and the Z-axis comes to the angle corresponding to the finished thickness of the work, allowing the work to be processed to have the required finished thickness.

Meanwhile, in the step of returning the tool, furthermore the tips, to the stand-by position after completing the processing, the adjustment is made to decrease the angle α to be smaller than that in the course of the processing step, in which the distance between the tips in the Z-axis direction increases to larger than the finished thickness of the work, so that a damage on the processed face caused by a hit by the tip can be prevented.

### BRIEF DESCRIPTION OF THE DRAWINGS

FIG. 1 is an elevation view of an NC lathe according to an embodiment of the present invention;

FIG. 2 is a schematic elevation view to explain a structure of a tool post of the NC lathe and an operation thereof in a stand-by step;

FIG. 3 is a schematic elevation view to explain an operation of the tool post of the NC lathe in a processing step;

FIG. 4 is a schematic elevation view to explain an operation of the tool post of the NC lathe in the processing step and in the stand-by step; and

FIG. 5 is a schematic elevation view to explain a modification example operation of the tool post of the NC lathe in the processing step and in the stand-by step.

### DETAILED DESCRIPTION OF THE PREFERRED EMBODIMENTS

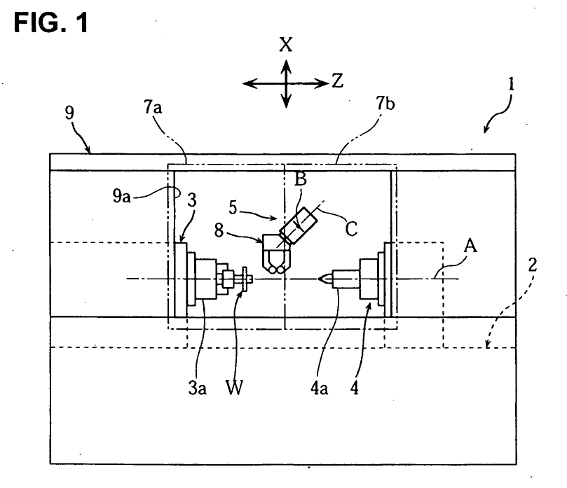

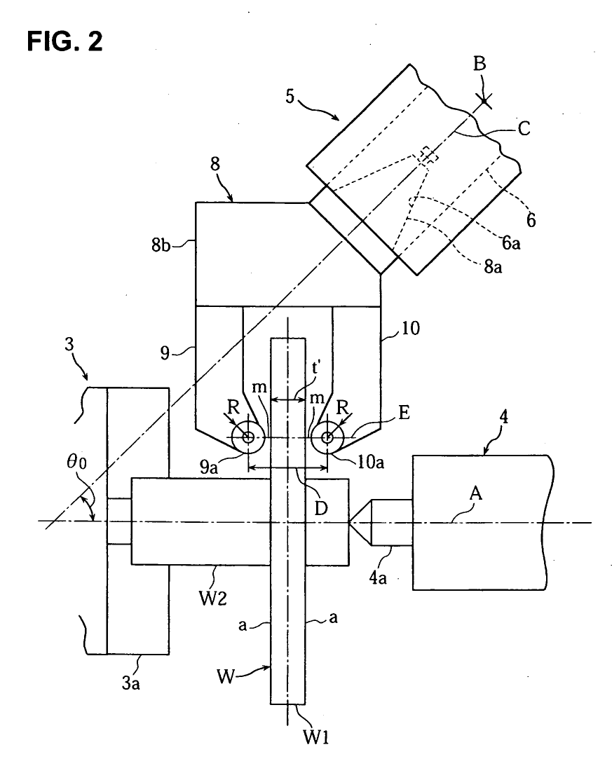

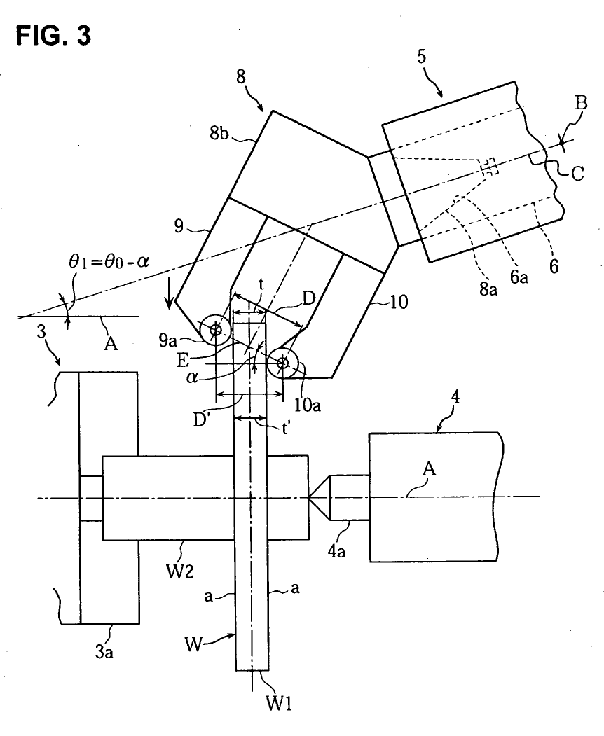

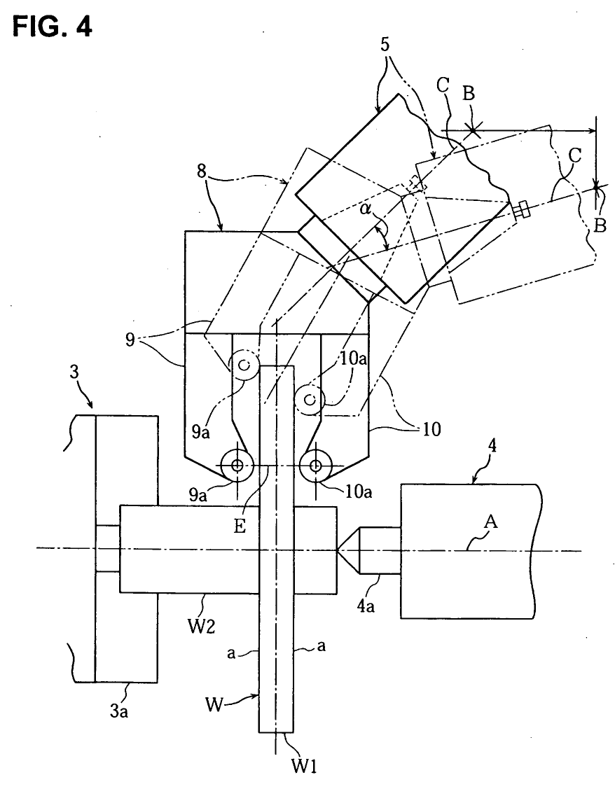

Hereinafter, embodiments of the present invention will be described based on the attached drawings. FIGS. 1 to 4 are views to illustrate an NC lathe (machine tool) according an embodiment of the present invention, in which FIG. 1 is an elevation view of the NC lathe, FIGS. 2 to 4 are schematic elevation views to illustrate a structure and an operation of tools fitted to a tool post.

In the drawings, “1” denotes the NC lathe processing a work W of a circular shape, for example, a disk plate being a main component of a disk brake gear for a vehicle by turning. When viewing from the front of the machine (FIG. 1), the NC lathe 1 has a schematic structure in which a spindle 3 is disposed on the left side of a bed 2 and a tailstock 4 is disposed on the right side of the bed 2 in a concentric manner so that they face to each other, and a tool post 5 is disposed in the back between the spindle 3 and the tailstock 4.

Note that, in FIG. 1, “9” denotes a cover surrounding the circumference of the lathe 1. A working opening 9a having an opening width reaching to the spindle 3 and the tailstock 4 is formed at the front portion of the cover 9. The working opening 9a is structured to be openable and closable by right and left slide doors 7b, 7a. The left slide door 7a is designed to open/close the spindle 3-side portion and the right slide door 7b is designed to open/close the tailstock 4-side portion.

The spindle 3 is secured onto the bed 2 and provided with a chuck 3a to grip the work W. The tailstock 4 is mounted on the bed 2 in a movable manner in the Z-axis (horizontal) direction and provided with a tailstock spindle 4a supporting an end face of the work W in the Z-axis direction by pressing.

The tool post 5 is disposed in a pivotable manner around a pivot point B orthogonal to a plane face containing an axis A (Z-axis) of the spindle 3 and the X-axis. The tool post 5 supports a tool spindle 6 by inserting the tool spindle 6 thereinto and a tool holder 8 is fitted to the tip portion of the tool spindle 6. The tool holder 8 includes a taper portion 8a fitted into a taper hole 6a of the tool spindle 6 and a holder potion 8b supporting a pair of tools 9, 10.

The paired tools 9, 10 have circular tips 9a, 10a, each of which has a radius R, respectively, at a tip portion thereof, and the paired tools 9, 10 are supported by the holder portion 8b in a manner that a distance D between the centers of the tips 9a, 10a can be adjusted manually and that the paired tools 9, 10 can be secured at adjusted positions. Here, the distance D between the tips 9a, 10a is adjusted to have additional spaces “m” “m”, in addition to the finished thickness “t” of the work being a processing object and diameter 2R of the tips. The above-described spaces “m”, “m” are provided for the purpose of preventing the tips 9a, 10a from damaging the processed face of the work when the tool, furthermore the tips, returns to the stand-by position after completing the processing. Note that, needless to say, the distance D may be structured to be automatically adjustable by a hydraulic mechanism, a ball screw mechanism, or the like.

Further, the work W gripped by the chuck 3a of the spindle 3 is a material to produce a disk plate. The work W includes a disk portion W1 having a disk shape and a thickness “t” and a holding section W2 provided at an axial center portion thereof in a combined manner with the disk portion W1. One end of the holding section W2 is held by the chuck 3a by being sandwiched thereby and the other end is supported by the tailstock 4. The lathe 1 according to the present embodiment is to process such that both braking faces a, a of the disk portion W1 have a predetermined parallelism to each other and, at the same time, the disk portion W1 has a predetermined thickness “t”.

In the present embodiment, it is structured that a straight line E connecting the centers of the tips 9a, 10a is in parallel with the axis A when an angle θ between the axis C of the tool spindle 6 of the tool post 5 and the axis A being in parallel with an axis Z of the spindle 3 is a predetermined angle θ0 (zero) degrees (for example, 45 degrees) (see FIG. 2).

In the processing step, the tool post 5 pivots, for example, only an angle of α degrees rightward around the pivot point B. Then, the angle between the tool spindle 6 and the axis A of the spindle 3 decreases to θ1 (=θ0−α), and at the same time, the distance between the tips 9a, 10a in the axis A direction reduces to D′. Based on this, the distance between turning points of the tips 9a, 10a in the axis A direction comes to the finished thickness “t”. In this state, the work W is rotated by moving the tool post 5 in the X-axis direction by the spindle 3, and the disk portion W1 is turned to have the predetermined parallelism and the finished thickness “t”.

Here, to be more precise, the pivot angle α of the tool post 5 to make the distance between cutting edges of the tips 9a, 10a be the above-described finished thickness “t” can be obtained by the equation below.
cos α=D′/D
=(t+2R)/D
α=cos⁻1{(t+2R)/D}

The above “t” is the finished thickness, “R” is the radius of the tips 9a, 10a, and “D” is the distance between the tips, which are already known, so that the angle α that the tool post 5 is needed to pivot can be obtained by the simple calculation.

Further, after completing the processing and in the stand-by step in which the tips 9a, 10a are made to return to original positions, adjustment is performed so that the angle α is made to be smaller than that in the processing step, in other words, the angle θ of the tool post 5 is made to be larger than the angle θ1, preferably, so that the angle θ comes to the angle θ0, and then, in this state, the tool post 5 returns in the X-axis direction to the stand-by position. Accordingly, spaces are generated between the cutting edges of the tips 9a, 10a and the processed faces of the work.

As described above, according to the present embodiment, the pivot angle θ of the tool post 5 is adjusted so that the angle α between the straight line E connecting the pair of tips 9a, 10a and the Z-axis comes to the angle corresponding to the finished thickness “t” of the work, in which it is not necessary to adjust the distance between the tips 9a, 10a in accordance with the finished thickness of the work, so that it is possible to process the work W to have the finished thickness “t” by adjusting the pivot angle θ of the tool post 5 only.

Further, in the present embodiment, the pivot angle of the tool post 5, furthermore the above-described angle α, is made constant without regard to the positional change in the X-axis direction of the tool post 5, so that the disk portion W1 of the work W can be processed to have a constant thickness in the radius direction.

Further, in the present embodiment, after completing the processing and in the stand-by step in which the tips 9a, 10a are returned to the stand-by position, the angle position of the tool post 5 is adjusted so that the angle α comes to be smaller than that in the processing step, in which the distance (D′−2R) between the cutting edges of the tips comes to be larger than the finished thickness “t” of the work, so that the damage on the processed face caused by being hit by the tip can be prevented.

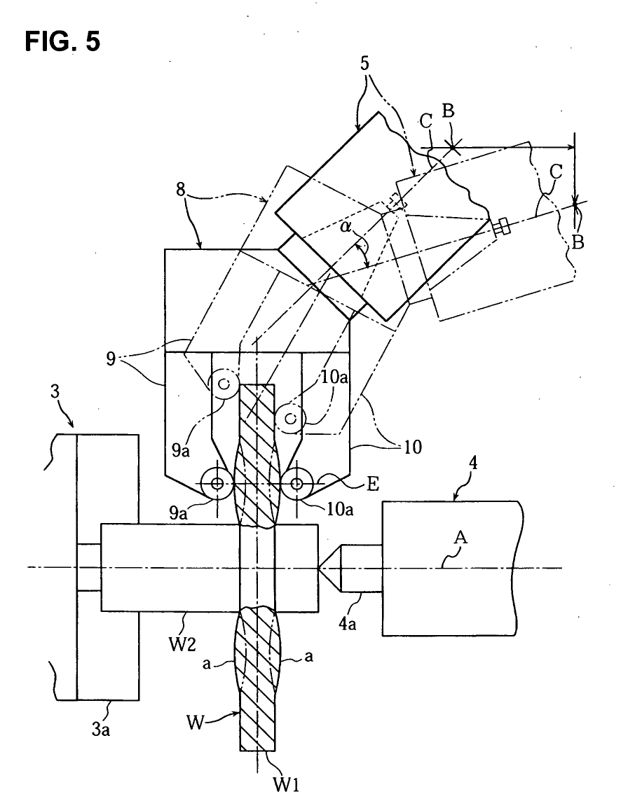

Here, in the above-described embodiment, although the case where the thickness “t” of the disk portion W1 of the work W is constant has been described, an applicable scope of the present invention is not limited to the processing of the work as described above. For instance, as shown in FIG. 5, the thickness of the disk portion W1 of the work W can be changed in a manner that the thickness increases gradually from the center side to the outer side in the radius direction and then decreases gradually to have the same thickness as of the circumference (see a solid line in the drawing). Furthermore, the disk portion W1 can be changed in a manner that the thickness decreases gradually from the center side to the outer side and then gradually increases to have the same thickness as of the circumference (see a chain double-dashed line in the drawing).

When changing the above thickness, it is possible to correspond to every thickness variation pattern by changing the angle θ of the tool post 5 with respect to the Z-axis, furthermore the angle α, continuously.

Note that, in the above-described embodiment, although the case where the tailstock 4 is provided has been described, needless to say, the present invention can also apply to the machine tool without the tailstock.

The invention may be embodied in other specific forms without departing from the spirit or essential characteristics thereof.

The present embodiments are therefore to be considered in all respects as illustrative and no restrictive, the scope of the invention being indicated by the appended claims rather than by the foregoing description, and all changes which come within the meaning and range of equivalency of the claims are therefore intended to be embraced therein.

What is claimed is:

1. A machine tool comprising:
a spindle rotating around a Z-axis extending in a horizontal direction;
a tool post disposed in a movable manner in the Z-axis direction and an X-axis direction orthogonal to the Z-axis direction and in a pivotable manner around a B-axis orthogonal to a plane face containing the X-axis and the Z-axis;
a tool including a pair of tips disposed to have a predetermined 1 o interval therebetween and fitted to said tool post; and
a tool post control unit adjusting a pivot angle of said tool post so that an angle α between a straight line connecting the pair of tips and the Z-axis comes to an angle corresponding to a finished thickness of a work.

2. The machine tool according to claim 1,
wherein said tool post control unit keeps the angle α constant without regard to a positional change in the X-axis direction of said tool post.

3. The machine tool according to claim 1,
wherein said tool post control unit changes the angle α accordance with the positional change in the X-axis direction of said tool post.

4. A work processing method in a machine tool having:
a spindle rotating around a Z-axis extending in a horizontal direction;
a tool post disposed in a movable manner in the Z-axis direction and an X-axis direction orthogonal to the Z-axis direction and in a pivotable manner around a B-axis orthogonal to a plane face containing the X-axis and the Z-axis; and
a tool including a pair of tips disposed to have a predetermined interval therebetween and fitted to said tool post, comprising:
a processing step processing the work in a state where the pivot angle of said tool post is adjusted so that the angle α formed by the straight line connecting the pair of tips and the Z-axis comes to the angle corresponding to the finished thickness of the work; and
a stand-by step returning to a stand-by position while it is in the state where the pivot angle of said tool post is adjusted so that the angle α after the processing is smaller than the angle in the course of said processing step.
